(19) United States
(12) Patent Application Publication
(10) Pub. No.: US 2023/0196264 A1
(43) Pub. Date: Jun. 22, 2023

(54) MULTI-MODAL TRANSIT SYSTEM

(71) Applicant: Cubic Corporation, San Diego, CA (US)

(72) Inventor: Christian Alain Senly, Hilversum (NL)

(73) Assignee: Cubic Corporation, San Diego, CA (US)

(21) Appl. No.: 18/085,377

(22) Filed: Dec. 20, 2022

Related U.S. Application Data
(60) Provisional application No. 63/291,857, filed on Dec. 20, 2021.

(51) Int. Cl. G06Q 10/0833; G06Q 10/0835; G06Q 10/02

(52) U.S. Cl. CPC G06Q 10/0833; G06Q 10/0835; G06Q 10/02

(57) ABSTRACT

A transit system and a transit method for managing logistics for an in-progress journey is disclosed. The transit system includes a mobility acquirer connected with two service providers. The system further includes user devices for multiple users. Each user device communicates with the mobility acquirer via an interface. The mobility acquirer receives and stores the preferences of users and updates logistics for the two service providers based on a start point, an endpoint, and the current location of the user device. The two service providers communicate with the mobility acquirer using another interface. The service providers track the availability of vehicles during a leg of the journey and calculate the resources entailed for the vehicles available for the leg. The system further includes a resource processor for allocating resources to the service providers by requesting resources for the journey from a resource wallet.

This application claims the benefit of and is a non-provisional of co-pending U.S. Provisional Application No. 63/291,857 by SENLY, entitled “TRANSIT TRANSACTION MODEL,” filed on Dec. 20, 2021, which is hereby expressly incorporated by reference in its entirety for all purposes.

### BACKGROUND

This disclosure generally relates to a transit system and, not by way of limitation, to provide logistics for an in-progress journey.

In a transportation network, passengers pre-organize their journey by selecting transport modes and in-transit services. The selection is generally based on duration, availability, and fee for the transport modes and the in-transit services. The passengers are charged a fee for the transport modes and each in-transit service availed by them, for which payments are made by the passengers to each service provider providing the transport modes and the in-transit services. The passengers use cash or perform electronic payments to communicate and conduct monetary transactions for each service provider.

### SUMMARY

In an embodiment, a transit system and method for managing logistics for an in-progress journey is disclosed. The transit system includes a mobility acquirer connected with two service providers. The system further includes user devices for multiple users. Each user device communicates with the mobility acquirer via an application programming interface (API). The mobility acquirer receives and stores the preferences of users and updates logistics for the two service providers based on a start point, an endpoint, and the current location of the user device. The two service providers communicate with the mobility acquirer using another API. The service providers track the availability of vehicles during a leg of the journey and calculate the resources entailed for the vehicles available for the leg. The system further includes a resource processor for allocating resources to the service providers by requesting resources for the journey from a resource wallet.

In one embodiment, a transit system and a transit method with logistics for a journey that is in-progress are disclosed. A mobility acquirer is connected with service providers, where rider devices specified for multiple riders communicate with the mobility acquirer to provide journey data. Each rider device communicates with the mobility acquirer via an application programming interface (API). The mobility acquirer receives and stores preferences of the multiple riders and updates logistics for transport modes and in-transit services provided by the service providers. The logistics are updated based on a start point of the journey, an endpoint of the journey, and a current location of the rider device. The service providers communicate with the mobility acquirer using another API. The service providers track availability of vehicles during a leg of the journey and calculate fares for the vehicles that are available for the leg of the journey. The fare is received by the service providers from the payment infrastructure organized by the mobility acquirer. The mobility acquirer grants access to the riders for the transport modes and in-transit services planned for the journey. The mobility acquirer continues to track location of each rider device till the completion of the journey in order to frequently/regularly/persistently manage and update logistics for the journey.

In another embodiment, a transit system with logistics for a journey that is in-progress is disclosed. The transit system includes a mobility acquirer and further includes rider devices for riders, wherein each of the rider devices includes a traveller tool comprising software that coordinates operation of the traveller tool with the mobility acquirer using a first API (application program interface). The transit system further includes a first provider of personal mobility and a second provider of personal mobility. The second provider of personal mobility coordinates operation with the mobility acquirer using a second API. The second provider of personal mobility:
tracks availability of vehicles for the journey during a leg of the journey, and
calculates resources entailed for the vehicles available for the leg of the journey.
   The transit system further includes a resource processor for allocating resources to the first provider and the second provider. The resource processor requests for resources for the journey once for division between the first provider and the second provider. The mobility acquirer stores preferences for each of the riders with respect to the first and the second providers of personal mobility. The mobility acquirer updates logistics for the journey for the traveller tool as each of the rider devices move between their respective start point, endpoint, and current location. The leg is a portion of the journey between the current location and the endpoint.

In still embodiment, a transit method with logistics for a journey that is in-progress is disclosed. Preferences for riders with respect to a first provider and a second provider of personal mobility are stored in a mobility acquirer. The riders are provided with respective rider devices. Each rider device includes a traveller tool comprising software that coordinates operation of the traveller tool with the mobility acquirer using a first application program interface (API). Availability of vehicles for a leg of the journey is tracked by the second provider. The second provider coordinates operation with the mobility acquirer using a second API. Resources entailed for the vehicles available for the leg of the journey are calculated by the second provider. Resources to the first provider and the second provider are allocated by a resource processor. The resources for the journey are requested by the resource processor once for division between the first provider and second provider. Logistics for the journey are updated for the traveller tool as each of the rider devices moves between their respective start point, endpoint and current location. The logistics for the journey are updated by the mobility acquirer. The leg is the portion of the journey between the current location and the endpoint.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram showing a transit system according to an embodiment of the present disclosure;

FIG. 2 illustrates a block diagram showing a mobility acquirer according to an embodiment of the present disclosure;

FIG. 3 illustrates a block diagram showing a rider device according to an embodiment of the present disclosure;

FIG. 4 illustrates a block diagram showing a service provider according to an embodiment of the present disclosure;

FIG. 5 illustrates a block diagram showing a resource processor according to an embodiment of the present disclosure;

FIG. 6 illustrates a swim lane diagram of a transit process executed by the transit system according to an embodiment of the present disclosure;

FIG. 7 illustrates a flowchart of a method for generating access for a transit process executed by the transit system according to an embodiment of the present disclosure; and

FIG. 8 illustrates a flowchart of a method for providing updates for logistics for a journey that is in-progress according to an embodiment of the present disclosure.

In the appended figures, similar components and/or features may have the same reference label. Further, various components of the same type may be distinguished by following the reference label by a second alphabetical label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Embodiments described herein are generally related to a transit system and a transit method with logistics for a journey that is in-progress or about to begin. In particular, some embodiments of the disclosure incorporate one or multiple arrangements with respect to elements that manage logistics for the journey. The disclosure specifically indicates the usage of a mobility acquirer, which receives and stores preferences from multiple riders having respective user devices. Each of the user devices is provided with a traveller tool that communicates with the mobility acquirer. The operations of the traveller tool are coordinated by the mobility acquirer via the first application programming interface (API). Further, a first provider of personal mobility and a second provider of personal mobility communicate with the elements of the transit system to manage logistics for the journey. The second provider of personal mobility coordinates with the mobility acquirer using a second API. The second provider tracks the availability of vehicles during a leg of the journey and calculates the resources entailed for the vehicles available for the leg of the journey. A resource processor requests resources for the journey once for division between the first provider and second provider. The mobility acquirer updates logistics for the journey for the traveller tool as each of the rider devices move between their respective start point, endpoint, and current location.

The resources allocated by the resource processor enable access to transportation modes and in-transit services for the journey for the riders, where an updated list of options related to the transportation modes and the in-transit services is also provided on the traveller tool in real-time. The updated list is prepared based on the leg of the journey that is still in progress and also considering the preferences of the riders, and the current location of the riders. In other words, the transportation modes and the in-transit services that were available at the start point of the journey may not be completely available at any further point of the journey, before reaching the endpoint of the journey. To indicate the unavailability of any of the transportation modes and the in-transit services, an update is provided on the traveller tool. The update is indicative of the available and/or alternate transportation modes and in-transit services. Furthermore, the mobility acquirer ensures that the riders make an individual payment for the overall journey, where a hassle-free payment infrastructure is provided to each rider for availing of the transportation modes and the in-transit services.

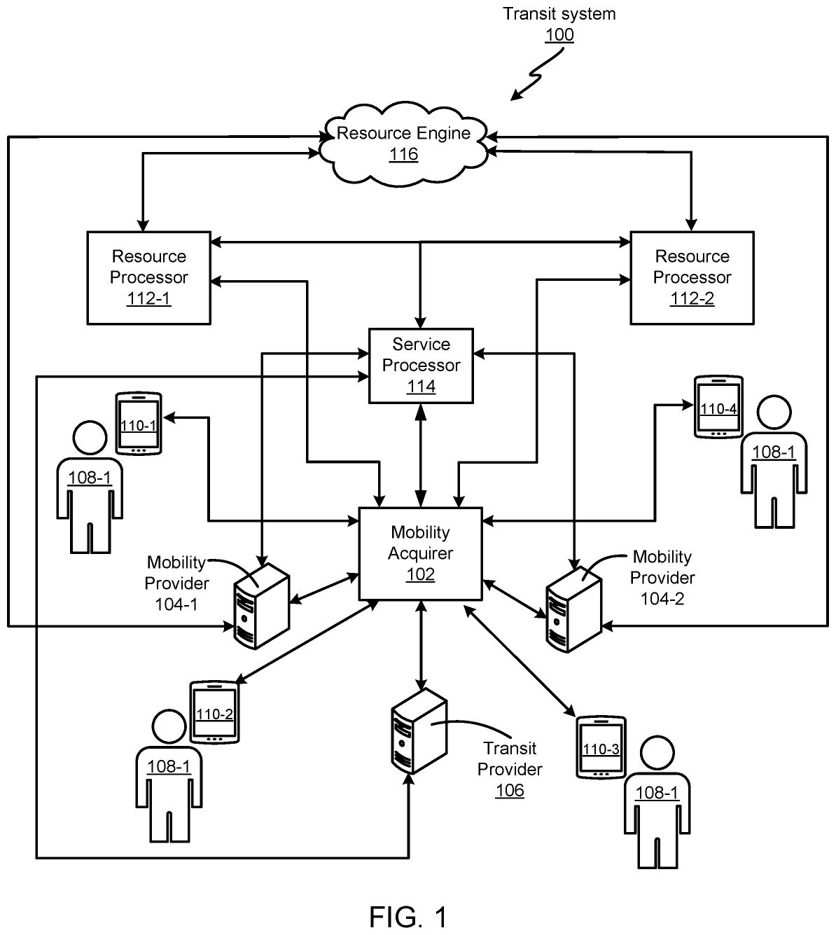

Referring to FIG. 1, illustrates a transit system 100 with logistics for a journey that is in-progress or being planned. The transit system 100 includes a mobility acquirer 102, two mobility providers 104-1, 104-2, a transit provider 106, rider devices 110-1, 110-2, 110-3, and 110-4, two resource processors 112-1, 112-1, a service processor 114, and a resource engine 116.

The transit system 100 includes two mobility providers 104-1, 104-2, however, the number of mobility providers 104-1, 104-2 may vary in different transit systems. As used herein the term “mobility providers 104-1, 104-2” may be interchangeably used as “the mobility provider 104” or the “service provider 104” throughout this disclosure. Furthermore, the two mobility providers 104-1, 104-2, and the transit provider 106 are depicted as different elements of the transit system 100, however in some embodiments, the terms “mobility provider 104” and “the transit provider 106” may be used interchangeably as “the mobility provider 104” or the “service provider 104” throughout this disclosure since the mobility provider 104 and the transit provider 106 have same or similar functions and operations with respect to other elements of the transit system 100. In some examples, an individual server may provide functions of mobility provider 104 and the transit provider 106. Further, in some examples the mobility provider 104 and the transit provider 106 may be interchangeably referred to as “a first provider of personal mobility” and “a second provider of personal mobility,” where the first provider and the second provider have the same or similar functions and operations with respect to other elements of the transit system 100. In an example, the first provider and/or the second provider is a transport organization that provides transportation services. In another example, the first provider and/or the second provider may not provide transport services and may provide a booking or may plan a travel arrangement from the transport organization. In yet another example, the first provider and the second provider may not provide transportation services and may provide in-transit services, such as the delivery of consumable goods for the journey.

Specifically in the embodiment of FIG. 1, the first provider and the second provider provide mobility solutions that are consumed as services by riders 108-1 to 108-4 during a journey. As used herein the term “riders 108-1 to 108-4 may be interchangeably used as “riders 108” or “the rider 108” throughout this disclosure. The services include transportation services having multiple transportation modes from public transport providers and/or private transport providers along with multiple in-transit services provided as add-on options for enhancing the convenience of travel for the riders 108 during the journey. The first and the second providers function along with other elements of the transit system 100, particularly the mobility acquirer 102 combine the transportation services and the in-transit services and provide a transit plan to the riders 108. The transit plan includes a combination of transportation modes along with in-transit services, selected by the riders 108 and available for the overall journey. The transportation services include, however, are not limited to the railway, bus, tram, taxi, limousine, subway. car sharing, ride sharing, bike, scooter, plane, and ferry, and may also include a wheel-chair service at a transit station. The in-transit services include, however, are not limited to accessing a vehicle parking facility at a transit station, receiving consumable goods and other shopping items during the journey, booking a hotel or any other accommodation within a route of the journey, selecting a specific seat on a transport vehicle, selecting a specific cabin class on the transport vehicle, selecting meal preferences on the transport vehicle, web-check-in at the transit station, and receiving medical services.

Specifically in the embodiment, of FIG. 1, the mobility acquirer 102 is an organizational server that is configured to obtain data from the riders 108 as well as from the first and second providers. The obtained data are compiled according to policies and is further transmitted to the first and the second providers. The policies are a set of protocols, rules or preferences defined by the first and second providers, based on which, access to the transportation services and the in-transit services by the riders is permitted or rejected. Various policies are stored in the mobility acquirer 102 upon obtaining data from the first and second providers. In this capacity, the mobility acquirer acts as an intermediary between the riders and the service providers, however, in some embodiments, the service providers may directly communicate with the riders via the rider devices. The mobility acquirer 102 stores preferences for the riders 108 with respect to the first and the second providers and updates logistics for the journey. In some embodiments, the first provider is a municipal transit system, and the mobility acquirer 102 is operated by the municipal transit system. The mobility acquirer 102 receives usage information for each of the riders for the first and the second providers. The preferences stored by the mobility acquirer 102 are communicated to the mobility acquirer by the rider devices 110-1 to 110-4. As used herein the term “rider devices 110-1 to 110-4” may be interchangeably referred to as “the rider devices 110” or “the rider device 110” throughout this disclosure.

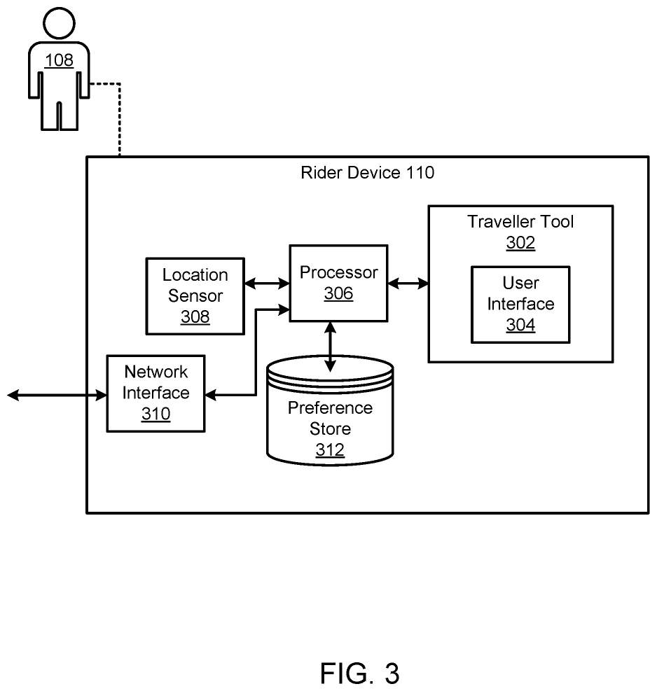

The rider device 110 includes a network interface (which will be later described in FIG. 3) that is configured to communicate over a communication network that includes one or multiple Wide Area Network (WAN) radios and one or multiple Local Area Network (LAN) radios. LAN radios of the wireless module can include one or multiple of WiFi (IEEE 802.11 standards), Bluetooth, or Zigbee (802.15.4), whereas WAN radios can include cellular (e.g., CDMA, TDMA, GSM, etc.), RFID, satellite (e.g., Comsat™ or Iridium™), and/or infrared transceivers. The rider device 110 includes a traveller tool 302 comprising software that coordinates operation of the traveller tool 302 with the mobility acquirer using a first application programming interface (API). Further, the rider device 110 is authenticated using the first API.

The first API defines a protocol for communicating information related to the preferences of the rider devices 110 between the service provider and the traveller tool 302. The API refers to a software interface that provides a means for a software application or a client application (e.g., the traveller tool 302) to communicate with a remote application, installed at the mobility acquirer 102 over, a network (e.g., the Internet) through a series of programming commands that call and/or invoke a routine to execute a specific process. In some embodiments, the first API may communicate back and forth between the traveller tool 302 and the first provider and/or the second provider. In some embodiments, the first API uses a secured tunnel. The secured tunnel is a communication link that is encrypted and is used to transmit and receive data over an encrypted connection. The encrypted connection helps to maintain the data privacy of the riders.

The mobility acquirer 102 processes journey data, obtained from the rider device 110, where the journey data includes a start point of the journey, an end point of the journey, and a current location of the rider device 110. A portion of the processed journey data is transmitted to the resource processors 112-1, 112-2. As shown in FIG. 1, the transit system 100 includes two resource processors 112-1, and 112-2, however, the number of resource processors may vary in some other embodiments as per the application attributes. As used herein the term “resource processors 112-1, 112-2” may be interchangeably referred to as “the resource processors 112 throughout this disclosure.

The resource processors 112-1, and 112-2 are communicably coupled to a resource engine 116. The resource engine 116 may be a closed and/or open payment system that uses points, government credits, transit pass credits, prepaid value, credit/debit cards, promotional coupons, and transfer credit from a mobility provider that is not a part of the transit system 100.

As described above the transit system 100 includes the service processor 114. The service processor is a central controller that controls the functions of various elements of the transit system 100, such as operating hardware, such as CPU or memory in the first and second providers, mobility acquirer 102, and resource processor 112-1, 112-2, and performs monitoring and control of this hardware. The term “service processor 14” may refer to a so-called processor or a processing unit including a processor, a memory, a board, and the like. The service processor may also receive an operation execution instruction from an external device that is not a part of the transit system 100 to control the CPU and execute various operations on the elements of the transit system 100.

In operation and as shown in FIG. 1, the rider devices 110-1 to 110-4 receive journey data from the respective riders 108. The journey data includes location coordinates related to a start point, an end point, and the current location of the rider device 110. The rider devices 110-1 to 110-4 further provide preferences of the riders 108. The preferences from the riders 108 are stored in the mobility acquirer 102, where riders 108 are authenticated using the first API. The first and/or the second provider simultaneously retrieve the journey data from mobility acquirer 102, where the preferences from the riders 108 are also retrieved. The service provider 104 tracks the availability of vehicles that are entailed by the riders 108 for the journey from the start point to the endpoint. In some embodiments, the start point, and the end point of the journey may have multiple legs, where the leg is the portion of the journey between the current location and the endpoint. The mobility acquirer 102 further updates the logistics based on the real-time location updates received from the rider devices 110. In some embodiments, the service provider 104 further tracks delivery goods that may have been ordered by the riders 108. In some embodiments, the service provider prepares a transit plan that includes multiple modes of transport selected based on preferences from the riders 108, policies from the service provider, and real-time location of the rider devices 110.

The service provider 104 further calculates the resources that are entailed in terms of fees for availing services in the journey. The calculated resources are transmitted to the resource processor 112. The resource processor 112 requests resources for the journey once for division between the first provider and second provider and the resources are allocated to the first provider and the second provider. In addition to the allocation of resources, the resource processor 112 monitors the consumption of the resource. The resource processor 112 has a threshold of resources for each of the riders 108 that can be consumed for the journey, and the resource processor 112 requests resources once the threshold is met. The resource processor 112 interfaces with multiple resource engines 116 or resource wallets assigned for respective riders 108. The term “resource wallets” here refers to software applications configured to initiate and/or conduct transactions (e.g., payment transactions, electronic payment transactions, and run by hardware devices, application programs and server-side software and/or databases for maintaining and providing transaction data to the resource engine 116. In some examples, a financial institution (e.g., an issuer institution) is a resource wallet provider. The resource processor 112 may be interfaced with multiple payment gateways and multiple payment providers.

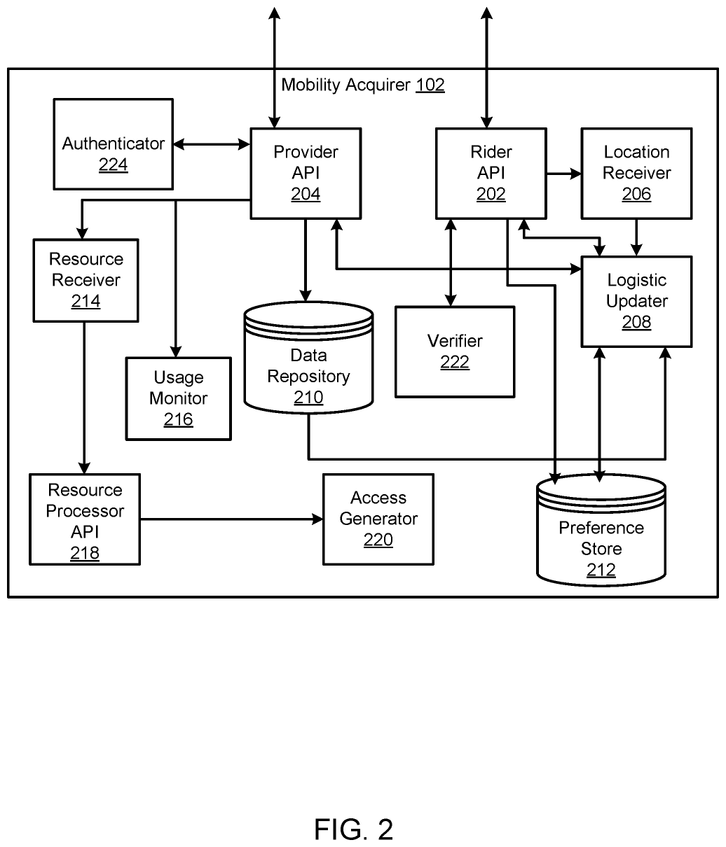

Referring to FIG. 2, illustrates the mobility acquirer 102 of FIG. 1. The mobility acquirer 102 is an entity that receives journey data from the riders 108 and processes transaction authorization requests from merchants or the first and the second providers or other entities and provides payment or guarantees of payment, in some cases through an agreement between the first and the second providers and an issuer institution, such as a bank. The mobility acquirer 102 has multiple computer systems that execute one or multiple software applications that are capable of performing any financial transaction. The mobility acquirer 102 includes a rider API 202. The rider API 202 is similar to the first API as described in FIG. 1. The rider API 202 is configured to communicate information related to the preferences of the rider devices between the first provider and the traveller tool 302. The mobility acquirer 102 further includes a verifier 222 that is communicably coupled to the rider API 202. Verifier 222 processes details related to a transit account of rider 108 and verifies rider 108. The term “verifier” may refer to any computing module that includes software and hardware components and program code configured to or implemented to validate the account information of the rider 108. The mobility acquirer 102 further includes a provider API 204. The provider API 204 authenticates the service providers 104. The provider API 204 is interchangeably used as the second API. The second API defines a protocol for communicating information related to the logistics for the journey between the mobility acquirer 102 and the second provider. In some embodiments, the second API uses a secured tunnel. The mobility acquirer 102 further includes an authenticator 224 that is communicably coupled to the provider API 204 to authenticate the first and the second provider. The term “authenticator” may refer to any computing module that includes software and hardware components and program code configured to or implemented to authenticate a service provider.

The mobility acquirer 102 further includes a data repository 210 for storing policies from the first and the second provider. The data repository 210 receives data from the provider API 204. The mobility acquirer has a preference store 212 that is communicably coupled to the rider API 202 to store the preferences provided by rider 108. The preference store 212 is further configured to exclusively store rider data, received along with the journey data. In other words, the mobility acquirer 102 is configured to take the ownership of the rider data received from the rider device 110 via the rider API 202, where the rider data remains with the mobility acquirer 102 throughout a course of the journey. In some embodiments, a portion of the rider data may be communicated to different entities or other elements of the transit system 100 depending upon application attributes. The usage of the secured tunnel by the rider API 202 further ensures that the rider data is communicated over an encrypted connection to facilitate data privacy as well as secured ownership of the rider data. The rider data is further protected by data privacy regulations, for example General Data Protection Regulation (GDPR) and Personally Identifiable Information regulation (PII). The rider data includes dynamically configured personal details of the rider 108, such as name, age, gender, mobility impediments or handicaps, current address, contact number, email address, applicable preferences for the mobility services, and payment details. The payment details in the rider data are further managed by the payment directives (e.g. PCI, PSD2). The payment details are further in compliance with locally applicable privacy, mobility, and payment regulations and directives. A subset of these regulations and directives may differ depending on a consent by the rider 108 with respect to the personal details, and the rider preferences. The subset is further adjusted based on interaction of the rider 108 with the mobility acquirer 102 while the rider 108 is in an ongoing journey.

As used herein, the data repository 210 and the preference store 212 are any storage medium that can store data. In some examples, data repository 210 and preference store 212 may be a database, filesystem, or another storage mechanism suitable for storing user data and customer engagement policies from multiple service providers. The mobility acquirer 102 further includes a location receiver 206 that receives location information of the rider devices 110. The location information is processed by a logistic updater 208 to update the logistics for a leg of the journey based on a real-time location of the rider devices 110. The logistic updater 208 simultaneously communicates with the data repository 210 and the preference store 212 to update the logistics in accordance with the data stored therein.

The mobility acquirer 102 further includes a resource receiver 214 that receives resource data, such as fees for availing multiple transport modes and in-transit services from the first and the second providers. The mobility acquirer 102 transmits the resource data to the resource processors 112-1, 112-2 as shown in FIG. 1. The resource data is transmitted via a resource processor API 218. The resource processor API 218 defines a protocol for communicating the resource data between the mobility acquirer 102 and the resource processors 112-1, and 112-2. A usage monitor 216 monitors the usage of services by the riders 108. The term “usage monitor” used herein is a program that recognizes a balance of transportation services and in-transit services availed by the riders 108 and permits or prohibits the execution of further consumption of the transportation services and the in-transit services according to the recognized balance of resources. This program permits the execution of further consumption of the transportation services and the in-transit services after confirming the availability of resources. Upon receiving of the resources from the first and the second providers, an access generator 220 grants access to riders 108 for availing the transportation services and the in-transit services. In some embodiments, the access generator 220 transmits an access ID to the rider device 110.

Referring to FIG. 3, illustrates a block diagram of a rider device 110. The rider device 110 comprises a traveller tool 302. The traveller tool 302 may, for example, be a traveller application designed to interact with the first and the second providers. In some example embodiments, the traveller tool 302 may provide operations to the riders 108 to add a pickup location and a drop location of a journey. In some example embodiments, the travel application may also report traffic in real time to provide an estimated time of arrival to a destination, provide information regarding traffic and/or road closures, and/or suggest a driving route, suitable transport modes, etc. In such embodiments, the drop location may be added to the traveller tool 302 to permit the riders 108 to generate a most suitable transit plan. The riders 108 also input the preferences related to the journey that is stored in a preference store 312.

The traveller tool 302 is provided with a user interface 304 to communicate with the rider API 202 of the mobility acquirer 102 of in FIG. 2. Specifically in the embodiment of FIG. 2, the user interface 304 refers to any visual, graphical, tactile, audible, sensory, or other means of providing information to and/or receiving information for performing communication between the rider device 110 and the mobility acquirer 102.

The rider device 110 further includes a processor 306 that may be a general-purpose one-chip- or multi-chip microprocessor (e.g., an ARM), a special purpose microprocessor (e.g., a digital signal processor (DSP)), a microcontroller, a programmable gate array, etc. The processor 306 may be referred to as a central processing unit (CPU). Although a processor 306 is shown in FIG. 3, in an alternative configuration, a combination of processors (e.g., an ARM and DSP) could be used.

The rider device 110 further includes a location sensor 308 that is communicably coupled to traveller tool 302 via the processor 306 to communicate the location information of the rider device 110 to the mobility acquirer 102, such that the location information is used to update the logistics in real-time. The location sensor 308 generates a location change status of the rider device 110, where the location change status indicates displacement of the rider device 110 during a period. In some embodiments, the mobility acquirer 104 receives the location change status from the rider device 110 or receives the location change status from a cloud service, to which the rider device 110 is also connected. In some embodiments, the location sensor 308 is a GPS transceiver that generates location coordinates with respect to the current location of the rider device 110. In some embodiments, the location change status is determined based on one or multiple connections of the rider device 110 with other computing devices in a surrounding environment. The surrounding environment may be a transit station, or a utility store, an eatery, etc. located on a route designed for the journey. The other computing devices may be desktop and laptop computers, and media devices having access points to connect to nearby telecommunication base stations.

The rider device 110 further includes a network interface 310 to provide wired or wireless connectivity to the rider device 110 with the mobility acquirer 102. In operation, data from the traveller tool 302 is communicated to the mobility acquirer 102 via the network interface 310. In some embodiments, network interface 310 may refer to any signal, data, and/or software interface with a component, network, and/or process. By way of a non-limiting example, a network interface may include one or multiple cellular (e.g., 3G, LTE/LTE-A/TD-LTE, GSM, and/or other cellular technology), Wi-Fi (802.11), WiMAX (802.16), PAN (e.g., 802.15), Ethernet (e.g., 10/100, 10/100/1000 (Gigabit Ethernet), 10-Gig-E, and/or other Ethernet implementations), FireWire (e.g., FW400, FW110, and/or other variation.), USB (e.g., USB2), MoCA, Coaxsys (e.g., TVnet™), radio frequency tuner (e.g., in-band or OOB, cable modem, and/or other protocol), IrDA families, and/or other network interfaces. For example, cellular data may be received at a baseband processor, wireless data may be received at a Wi-Fi and/or BT module, Ethernet data may be received at an Ethernet networking modem, etc.

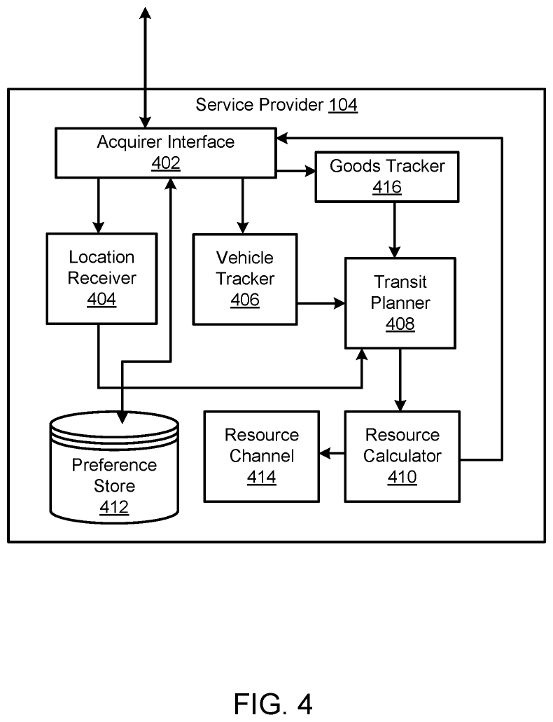

Referring to FIG. 4, illustrates a block diagram of the service provider 104 of FIG. 1. The service provider 104 as used herein is a combination of the mobility provider 104 and the transit provider 106 as described in FIG. 1. Further, the service provider 104 may refer to a company or group of companies that provide multiple services as a bundled service for an overall journey requested by the rider 108. Service provider 104 is not limited to representing one specific company and may be used as a term indicating an association of multiple service providers.

The service provider 104 includes an acquirer interface 402 that is configured to communicate with the provider API 204 of the mobility acquirer 102. The acquirer interface 402 provides journey data to multiple elements of the service provider 104. A preference store 412 is used to store policies of customer engagement. The location receiver 406 receives a real-time location of the rider device 110, which is used by a transit planner 408 to mark a starting point of the journey as well the current location of the rider device 110. A vehicle tracker 406 uses the journey data to track the availability of transport vehicles that may form a part of a multi-modal transportation plan for the journey.

The availability of the transport vehicles is communicated to the transit planner 408. In some embodiments, the service provider 104 sources for delivery goods for use on the journey, which is tracked by a delivery goods tracker 416. The transit planner 408 compiles data received from the vehicle tracker 404 and the delivery goods tracker 416 in order to generate a proposed transit plan to be displayed on the traveller tool 302 of FIG. 3. A resource calculator 410 calculates the resources, such as fee and charges for transportation services and in-transit services and further supplements the proposed transit plan with the fee and charges details for availing the transportation services and the in-transit services.

Service provider 104 is further provided with a resource channel 414, which is a type of payment channel that may provide access to one or multiple types of payment gateways and user payment modes, for service provider 104. The user payment modes may refer to methods by which a user compensates a vendor for various goods and services. The user payment mode may be a specific type or form of the payment system, by which the user attempts to compensate the vendor for the goods or services.

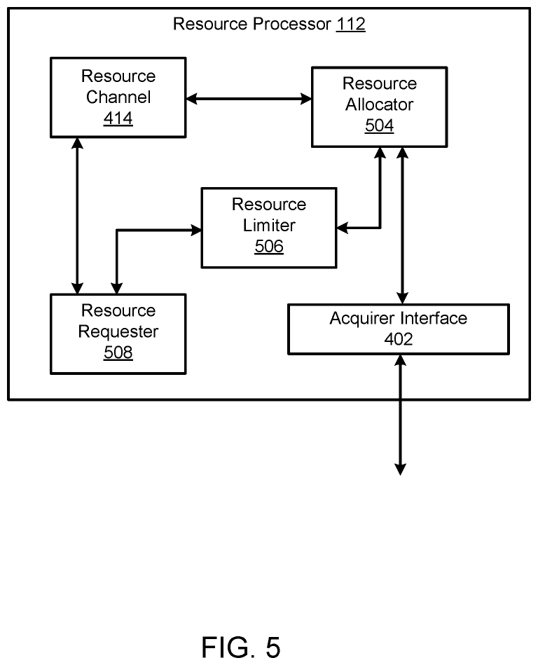

Referring to FIG. 5, illustrates a block diagram of the resource processor 112. The resource processor 112 is configured to transmit data to a payment infrastructure, for example, the resource engine 116 of the transit system 100 of FIG. 1. The resource processor 112 further includes an acquirer interface 402, which is similar to the acquirer interface of the service provider of FIG. 4. The resource processor 112 is further configured to request resources that are to be allocated to the first provider and second provider, where the resource processor 112 requests resources for the journey once for division between the first provider and second provider. A resource requester 508 is configured to request resources from the resource engine 116 via the resource channel 414. The resource processor 112 further includes a resource allocator 504 that receives resources from the resource engine 116 via resource channel 414. The resource allocator 504 further allocates the resources to the first provider and the second provider via the acquirer interface 402. A resource limiter 506 is further configured to check for a threshold of resources for each of the plurality of riders that can be consumed for the journey and the resource processor 112 requests resources once the threshold is met.

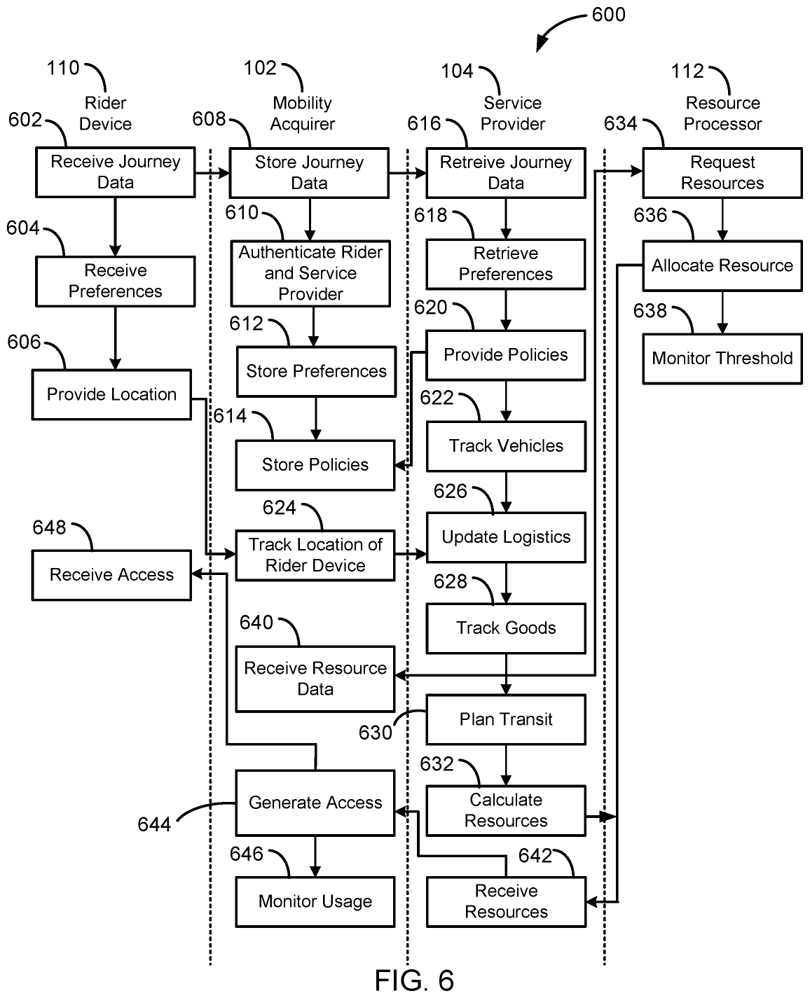

Referring to FIG. 6, illustrates a swim lane diagram 600 of a transit process executed by various elements of the transit system 100. Beginning at block 602, the rider device 110 receives journey data from the respective riders 108. The journey data includes location coordinates related to a start point, an end point, and the current location of the rider device 110. At block 604, rider device 110 further receives preferences from the riders 108. At block 606, the rider device 110 provides a location to the mobility acquirer 102. At block 608, the journey data is stored in the mobility acquirer 102, where the riders 108 are authenticated using the first API at block 610. At block 612, the preferences from the rider are stored in the mobility acquirer 102. At block 614, the policies from the service provider are stored in the mobility acquirer 102. At block 616, the journey data is retrieved by the mobility acquirer 102, where the preferences from the riders 108 are also retrieved at block 618.

At block 620, the service provider 104 provides policies, that define rules for availing services by the riders 108, which are again provided to the mobility acquirer 102. At block 622, the service provider 104 tracks the availability of vehicles that are entailed by the riders 108 for the journey from the start point to the endpoint. At block 624, the location of the rider is tracked by the mobility acquirer 102 and further communicated to the service provider 104 for updating logistics at block 626. At block 628, the service provider 104 further tracks delivery goods that may have been ordered by the riders 108 to further update logistics.

At block 630, the service provider 104 prepares a transit plan that includes multiple transport modes selected by the riders 108 based on the preferences, the policies from the service provider 104, and real-time location of the rider devices 110. At block 632, service provider 104 further calculates the resources that are entailed in terms of fees for availing services in the journey. At block 634, the calculated resources are transmitted to the resource processor 112. At block 636, the resource processor 112 requests resources for the journey once for division between the first provider and second provider, and the resources are allocated to the first provider and the second provider. At block 638, resource processor 112 monitors the consumption of the resource. The resource processor 112 has a threshold of resources for each of the riders 108 that can be consumed for the journey, and the resource processor 112 requests resources once the threshold is met. The resource processor 112 interfaces with multiple resource engines 116 or resource wallets assigned for respective riders 108. The resource processor 112 may be interfaced with multiple payment gateways and multiple payment providers.

At block 640, the resource data is received by mobility acquirer 102, where the resource data indicates confirmation of the allocation of resources. At block 642, the resources are received by the service provider 104. At block 644, the resources and the resource data are further used to generate access for rider 108. At block 646, the usage monitor 216 is activated to monitor the usage of services by the riders. At block 648, the generated access is provided to the rider.

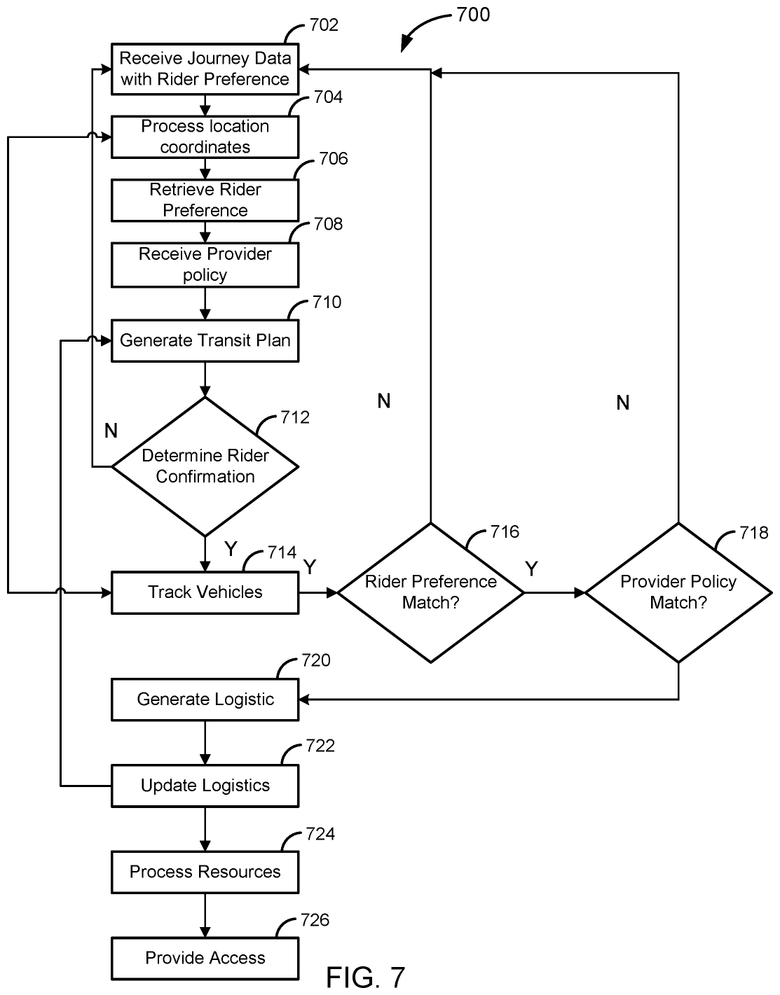

Referring to FIG. 7, illustrates a flowchart of a method 700 for generating access for a transit process executed by the transit system 100 of FIG. 1. Some blocks of method 700 may be performed by the system 100 and by utilizing processing resources through any suitable hardware, software, or a combination thereof.

At block 702, journey data along with rider preferences is received by the rider device 110. The journey data includes location nodes provided by the rider 108, where rider preferences include choices of the rider 108 with respect to transport modes and in-transit services to be used in a journey.

At block 704, location coordinates received in the journey data are processed by the mobility acquirer 102 to identify a start point of the journey, an end point of the journey, and a current location of the rider device 110 during the journey.

At block 706, rider preferences are retrieved by the mobility acquirer 102, which is further stored in the preference store 212 of the mobility acquirer 102.

At block 708, provider policies are received by the mobility acquirer 102. The provider policies are further stored in the data repository. Data related to rider preferences and provider policies is complied with, such that the availability of corresponding transport modes can be checked in advance before the rider boards any mode of transport. This prevents hassle for the rider and the service provider during the in-progress journey.

At block 710, a transit plan is generated. The transit plan is primarily inclusive of:
Modes of transport that will be entailed to complete the journey from the start point to the endpoint. The term “start point” used herein is a point from where the journey is to be started. For example, the start point of the journey is from a shopping complex that is 3 miles in distance from the nearest train station and 6 miles away from the nearest airport. Likewise, the term “endpoint” used herein is a point where the journey will end. For example, the endpoint of the journey is at a housing society located 4 miles away from the nearest train station and 15 miles away from the nearest airport. The modes of transport in the transit plan indicate the most convenient way to commute between the start point and end point with respect to time and travel fare. For example, the transit plan may first suggest a taxi ride from the shopping complex to the nearest airport. Then an economy class air travel between the nearest airport at the start point and the nearest airport at the endpoint along with the suggestion of the last mile connectivity to the endpoint via an e-scooter.
In-transit services that are entailed by the rider for the overall journey. In example, the rider may choose an option of air travel for commute, where the rider has requested for waiting at a premium lounge of the air service provider. The transit plan will then indicate flights where the riders can avail of services for waiting at the premium lounge.

Upon generating the transit plan, it is transmitted to the rider for review.

At block 712, the confirmation from the rider is determined by the mobility acquirer 102, where upon rejection by the rider, the mobility acquirer generates another transit plan having different options for modes of transport or in-transit services.

At block 714, the rider confirmation is received by the mobility acquirer 102, upon which the service provider 104 tracks vehicles that are to form part of the transport modes in the transit plan.

At block 716, the available vehicles are tracked and checked for matching the preferences of the rider. For example, the rider may have opted for a window seat for air travel. In that case, the flight will be checked for the availability of window seats. Upon the unavailability of the window seat, the rider is provided with an option to re-enter journey data with different preferences.

At block 718, the available vehicles that match rider preferences are checked for parameters, in which the combination of available vehicles with rider preferences matches with policies of the service provider 104. For example, a rider may opt for a train journey along with the usage of an e-scooter for last-mile connectivity from the last train station to his home. And for that slated time, the e-scooter remains operational due to a daily maintenance schedule. In that case, the rider is notified to re-enter journey data with different preferences.

At block 720, the logistics are generated for the journey that is inclusive of multiple modes of transport that match rider preferences and provider policies.

At block 722, the logistics are updated by the mobility acquirer 102 based on the real-time location tracking of the rider devices during a leg of the journey.

At block 724, resources for availing the multiple modes of transport along with the in-transit services are calculated by the service provider and forwarded to the resource processor 112 via the mobility acquirer 102.

At block 726, the rider is provided with access to multiple modes of transport and in-transit services. The access is provided after the successful completion of the resource transaction between the resource processor 112 and the service provider.

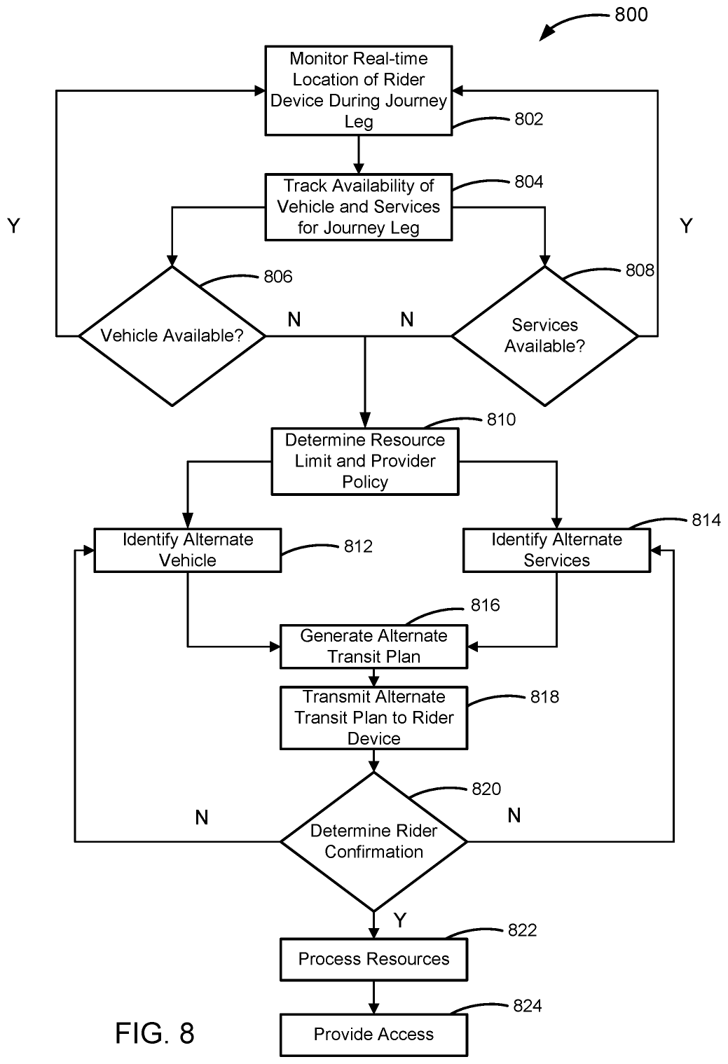

Referring to FIG. 8 illustrates a flowchart of a method for providing updates for logistics for an in-progress journey. Some blocks of method 800 may be performed by the transit system 100 and by utilizing processing resources through any suitable hardware, software, or a combination thereof.

At block 802, the real-time location of the rider device 110 is monitored during a leg of the journey. The mobility acquirer 102 performs the monitoring so that the journey details can be recorded for updating the booked modes of transport. In example, rider 108 may decide to change the end point of the journey while arriving at the last train station of a train journey. In that case, an already booked uber taxi may be provided with an update of a canceled ride by the rider.

At block 804, in a different scenario as compared to the example at block 802, rider 108 may be provided with an update of change in the transit plan based on the current location of the rider device and unavailability of a certain transport mode at the time of arrival of the rider at the corresponding transport station.

At block 806, the availability of vehicles is tracked, where if the vehicles are available, the process of monitoring the location of rider device 110 continues to execute.

At block 808, the availability of in-transit services is tracked, where if the vehicles are available, the process of monitoring the location of rider device 110 continues to execute.

At block 810, upon identifying the unavailability of either of the vehicles or services, the mobility acquirer checks for a resource limit and provider policies. For example, the mobility acquirer 102 is programmed with an instruction to cap a resource limit of a journey for a particular rider at 200 dollars.

At block 812, upon determining the resource limit and the provider policy availability of alternate vehicles is identified.

At block 814, upon determining the resource limit and the provider policy availability of alternate services is identified.

At block 816, an alternate transit plan is generated, which is inclusive of alternate modes of transport or vehicles and/or alternate services. In addition to the examples, at blocks 810, 812, and 814, the alternate transit plan is generated and a total price for alternate modes of transport or vehicles and/or alternate services will be less than or equal to 200 dollars. In some embodiments, the mobility acquirer 102 is programmed with an instruction to cap a resource limit of a journey for a particular rider based on credit available in a linked wallet. The linked wallet refers to a funding source that is communicably coupled with the mobility acquirer 102 to transact resources.

At block 818, the alternate transit plan is transmitted to the rider device for rider review.

At block 820, the confirmation from the rider is determined by the mobility acquirer 102, whereupon rejection by the rider 110, the mobility acquirer 102 identifies different modes of transport or in-transit services.

At block 822, resources for availing the multiple modes of transport along with the in-transit services are calculated by the service provider 104 and are forwarded to the resource processor 112 via the mobility acquirer 102.

At block 824, rider 108 is provided with access to multiple modes of transport and in-transit services. The access is provided after successful completion of a resource transaction between the resource processor 112 and the service provider 104.

Such transit systems and methods help build a transport network that provides multiple modes of transport along with the provision of multiple in-transit services. The multiple modes of transport and multiple in-transit services are provided flexibly, such that the rider has options for changing the transport modes and opting for different transit services based on the real-time location of the rider or even if the journey is in-progress. Furthermore, the rider is provided with the feature of using a unified payment infrastructure for paying for transport modes and in-transit services.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A transit system with logistics for a journey that is in-progress, the transit system comprising:
a mobility acquirer;
a plurality of rider devices for a plurality of riders, wherein each of the plurality of rider devices includes a traveller tool comprising software that coordinates operation of the traveller tool with the mobility acquirer using a first API;
a first provider of personal mobility;
a second provider of personal mobility that coordinates operation with the mobility acquirer using a second API, wherein the second provider of personal mobility:
tracks availability of vehicles during a leg of the journey, and
calculates resources entailed for the vehicles available for the leg of the journey; and
a resource processor for allocating resources to the first provider and second provider, wherein the resource processor requests resources for the journey once for division between the first provider and second provider, wherein:
the mobility acquirer stores preferences for each of the plurality of riders with respect to the first and second providers of personal mobility,
the mobility acquirer updates logistics for the journey for the traveller tool as each of the plurality of rider devices move between their respective start point, endpoint and current location, and
the leg is a portion of the journey between the current location and the endpoint.

2. The transit system with the logistics for the journey that is in-progress as claimed in claim 1, wherein:
the first API defines a protocol for communicating information related to the preferences of the plurality of rider devices between the first provider and the traveller tool, and
the second API defines a protocol for communicating information related to the logistics of the journey between the mobility acquirer and the second provider.

3. The transit system with the logistics for the journey that is in-progress as claimed in claim 1, wherein each of the plurality of rider devices authenticates through the first API.

4. The transit system with the logistics for the journey that is in-progress as claimed in claim 1, wherein the second provider of personal mobility authenticates for use of the second API.

5. The transit system with the logistics for the journey that is-in progress as claimed in claim 1, wherein the second provider of personal mobility sources goods for use on the journey.

6. The transit system with the logistics for the journey that is-in progress as claimed in claim 1, wherein the first provider is a municipal transit system, and wherein the mobility acquirer is operated by the municipal transit system.

7. The transit system with the logistics for the journey that is-in progress as claimed in claim 1, wherein the mobility acquirer receives usage information for each of the plurality of riders for the first and the second providers of personal mobility.

8. The transit system with the logistics for the journey that is-in progress as claimed in claim 1, wherein the first API or/the second API uses a secured tunnel.

9. The transit system with the logistics for the journey that is-in progress as claimed in claim 1, wherein the resource processor interfaces with a plurality of resource wallets specified for the plurality of riders.

10. The transit system with the logistics for the journey that is-in progress as claimed in claim 1, wherein the resource processor has a threshold of resources for each of the plurality of riders that can be consumed for the journey, and the resource processor requests resources once the threshold is met.

11. A transit method with logistics for a journey that is in-progress, the method comprising:
storing, in a mobility acquirer, preferences for a plurality of riders with respect to a first provider and a second provider of personal mobility,
wherein each of the plurality of riders is provided with a plurality of rider devices, and
wherein each of the plurality of rider devices includes a traveller tool comprising software that coordinates operation of the traveller tool with the mobility acquirer using a first API;
tracking availability of vehicles for a leg of the journey by the second provider,
wherein the second provider coordinates operation with the mobility acquirer using a second API;
calculating, by the second provider, resources entailed for the vehicles available for the leg of the journey;
allocating resources to the first provider and second provider,
wherein resources for the journey are requested by a resource processor once for division between the first provider and second provider;
updating logistics for the journey for the traveller tool as each of the plurality of rider devices move between their respective start point, endpoint and current location, and
wherein the logistics for the journey are updated by the mobility acquirer; and the leg is a portion of the journey between the current location and the endpoint.

12. The transit method with logistics for the journey that is-in progress as claimed in claim 11, wherein the method further authenticates each plurality of rider devices.

13. The transit method with logistics for the journey that is-in progress as claimed in claim 11, wherein the method further comprises sourcing of goods for use on the journey.
